(19) United States
(12) Patent Application Publication
(10) Pub. No.: US 2026/0065756 A1
(43) Pub. Date: Mar. 5, 2026

(54) GAME DEVICE AND LOTTERY GAME MACHINE

(71) Applicant: SEGA CORPORATION, Tokyo (JP)

(72) Inventors: Takayuki Hoshino, Tokyo (JP); Yuto Sugita, Tokyo (JP)

(73) Assignee: SEGA CORPORATION, Tokyo (JP)

(21) Appl. No.: 19/385,599

(22) Filed: Nov. 11, 2025

Related U.S. Application Data
(63) Continuation of application No. PCT/JP2024/007083, filed on Feb. 27, 2024.

(30) Foreign Application Priority Data
May 11, 2023 (JP) 2023-078715

(51) Int. Cl. G07F 17/38; G07F 17/32

(52) U.S. Cl. CPC G07F 17/38; G07F 17/3244; G07F 17/329; G07F 17/3297

(57) ABSTRACT

A game device includes: a play field in which a game is played using balls; a supplier that supplies the balls to the play field; and a storage that is configured to store the balls discharged from the play field and allow the balls to move towards the supplier. The supplier has a conveying unit that conveys the balls to the play field and a ball guide that guides the balls from the storage successively to the conveying unit. The ball guide includes: a guide path that passes the balls from the storage toward the conveying unit; and an adjuster that allows at least one of the balls near an entrance of the guide path on a side of the storage to move to another position in the storage, in response to the one of the balls being stacked to be above a height of the entrance.

### BACKGROUND

### Technical Field

The present invention relates to a game device and a lottery game machine.

### Description of Related Art

Conventionally, a game device having a conveying unit that conveys balls one by one to a play field is known (see, for example, patent document 1).

### PATENT DOCUMENTS

[Patent Document 1] JP 2000-84148 A

However, the conventional lottery game device disclosed in patent document 1 employs a push plate that pushes jammed balls into a recovery lane in order to solve a problem of balls becoming jammed in a ball movement path. However, when the push plate presses against a jammed ball, guidance of the ball to the conveying unit is temporarily stopped, which can cause the conveying unit to be unable to convey the ball, and a time difference between the start of the conveying unit's conveying operation and the time the no longer jammed ball is guided to the conveying unit may cause the ball to become jammed due to engagement between the conveying unit and the ball. Furthermore, a working end of the push plate is located near the conveying unit, and thus the push plate may not be able to eliminate the problem of balls becoming jammed in the ball movement path located away from the conveying unit. In this way, when the push plate cannot solve the problem of ball jamming, the conveying unit will not be able to convey the balls stably, which may affect the player's satisfaction with the game.

### SUMMARY

One or more embodiments of the present invention provide a game device and a lottery game machine that avoid the occurrence of ball jams in the conveying unit and achieve stable ball conveyance by the conveying unit.

The game device of one or more embodiments of the present invention is configured to have: a play field in which a game is played using balls; a supplier that supplies the balls to the play field; and a storage that is configured to store balls discharged from the play field and allow the balls to move towards the supplier, wherein the supplier comprises: a conveying unit that conveys the balls to the play field; and a ball guide that guides the balls from the storage successively to the conveying unit, and the ball guide comprises: a guide path that passes the balls from the storage toward the conveying unit; and an adjuster that allows at least one of the balls near an entrance of the guide path on a side of the storage to move to another position in the storage, in response to the one of the balls being stacked to be above a height of the entrance.

When adopting this configuration, according to the present invention, it is possible to avoid the occurrence of ball jams in the conveying unit and achieve stable ball conveyance by the conveying unit, thereby providing a game device and a lottery game machine that can improve player satisfaction with the game.

In the game device according to one or more embodiments of the present invention, the guide path may have the entrance and an exit located on a side of the conveying unit, the entrance may be formed to allow the balls from the storage to enter the guide path one by one, and the exit may discharge the balls in the guide path one by one to the conveying unit.

By adopting such a configuration, the guide path can be used to guide each ball to the conveying unit with a simple configuration, and ball jamming while moving toward the conveying unit can be avoided.

In the game device according to one or more embodiments of the present invention, among a plurality of rows, before the balls sequentially enter the entrance from the storage and are discharged from the exit, the guide path may align the balls in one row in which adjacent balls are in contact with each other.

By adopting such a configuration, it is possible to easily avoid the occurrence of ball jamming due to engagement between the conveying unit and the balls.

In the game device according to one or more embodiments of the present invention, the adjuster may have a piston that pushes the balls in a direction away from the entrance.

By adopting such a configuration, it is possible to reliably prevent ball jamming at the entrance side of the guide path using a simple configuration.

In the game device according to one or more embodiments of the present invention, the supplier further comprises: a driver that drives a ball conveying operation of the conveying unit, and the piston of the adjuster is configured to be engageable with the conveying unit, and in a state that the piston engages with the conveying unit, a piston operation of the piston may be driven by the driver.

When such a configuration is adopted, the conveying unit and the adjuster can be driven by a single power source, thereby simplifying the structure and reducing manufacturing costs.

In the game device according to one or more embodiments of the present invention, the guide path may be defined by an adjuster and a guide plate that faces the adjuster and supports the balls.

When such a configuration is adopted, the guide path can be formed with a simple configuration, thereby making it possible to reduce the number of components.

The lottery game machine of one or more embodiments of the present invention is provided with a lottery game unit that conducts a lottery game using any one of the game devices described above, an input slot that receives a game start medium input by a player, a medium dispenser that dispenses a game result medium to the player, and a controller configured to dispense the game result medium corresponding to a lottery result of the lottery game that was started in response to the input slot receiving the game start medium, to the medium dispenser based on the lottery result.

By adopting such a configuration, it is possible to use a simple configuration to avoid ball jamming in the first lottery game unit, to ensure that the lottery game is carried out stably, and to improve the player's satisfaction with the game.

According to one or more embodiments of the present invention, it is possible to provide a game device and a lottery game machine that can avoid the occurrence of ball jams in the conveying unit and achieve stable ball conveyance by the conveying unit.

### BRIEF DESCRIPTION OF DRAWINGS

FIG. 1 is a perspective view illustrating a configuration of a lottery game machine according to one or more embodiments.

FIG. 2 is a schematic diagram illustrating a state in which the lottery game machine according to one or more embodiments is used.

FIG. 3 is a perspective view illustrating a configuration of the lottery game machine according to one or more embodiments.

FIG. 4 is a diagram illustrating a configuration of a front side of a first lottery game unit of the lottery game machine according to one or more embodiments.

FIG. 5 is a diagram illustrating a configuration of a back side of the first lottery game unit of the lottery game machine according to one or more embodiments.

FIG. 6 is a cross-sectional diagram illustrating a configuration of an attachment part of the first lottery game unit of the lottery game machine according to one or more embodiments.

FIG. 7 is a diagram illustrating a configuration of the supplier of the first lottery game unit of the lottery game machine according to one or more embodiments, as viewed from the front side.

FIG. 8 is a diagram illustrating a configuration of the supplier of the first lottery game unit of the lottery game machine according to one or more embodiments, as viewed from the back side.

FIG. 9 is a diagram for describing an operation of supplying balls to the play field by the supplier of the first lottery game unit of the lottery game machine according to one or more embodiments.

FIG. 10 is a diagram for describing an operation of supplying balls to the play field by the supplier of the first lottery game unit of the lottery game machine according to one or more embodiments.

FIG. 11 is a diagram for describing an operation of supplying balls to the play field by the supplier of the first lottery game unit of the lottery game machine according to one or more embodiments.

FIG. 12 is a diagram for describing an operation of supplying balls to the play field by the supplier of the first lottery game unit of the lottery game machine according to one or more embodiments.

FIG. 13 is a diagram for describing an operation of supplying balls to the play field by the supplier of the first lottery game unit of the lottery game machine according to one or more embodiments.

FIG. 14 is a diagram illustrating a configuration of a second lottery game unit of the lottery game machine according to one or more embodiments.

FIG. 15 is a diagram illustrating a conveying unit of the second lottery game unit of the lottery game machine according to one or more embodiments.

FIG. 16 is a diagram illustrating a top end portion of the conveying unit of the second lottery game unit of the lottery game machine according to one or more embodiments.

FIG. 17 is a flowchart illustrating control of the lottery game by a controller of the lottery game machine according to one or more embodiments.

### DETAILED DESCRIPTION OF EMBODIMENTS

The embodiments will be described below with reference to the drawings. In addition, unless otherwise specified, the positional relationships such as up, down, left, and right in the drawings are based on the positional relationships illustrated in the drawings. Furthermore, the dimensional ratios of the drawings are not limited to those illustrated in the drawings. Furthermore, the following embodiments are mere examples for explaining the present invention, and is not intended to limit the present invention to only the embodiments. Furthermore, the present invention can be modified in various ways without departing from the spirit and scope of the invention.

### <Summary of Lottery Game Machine 1>

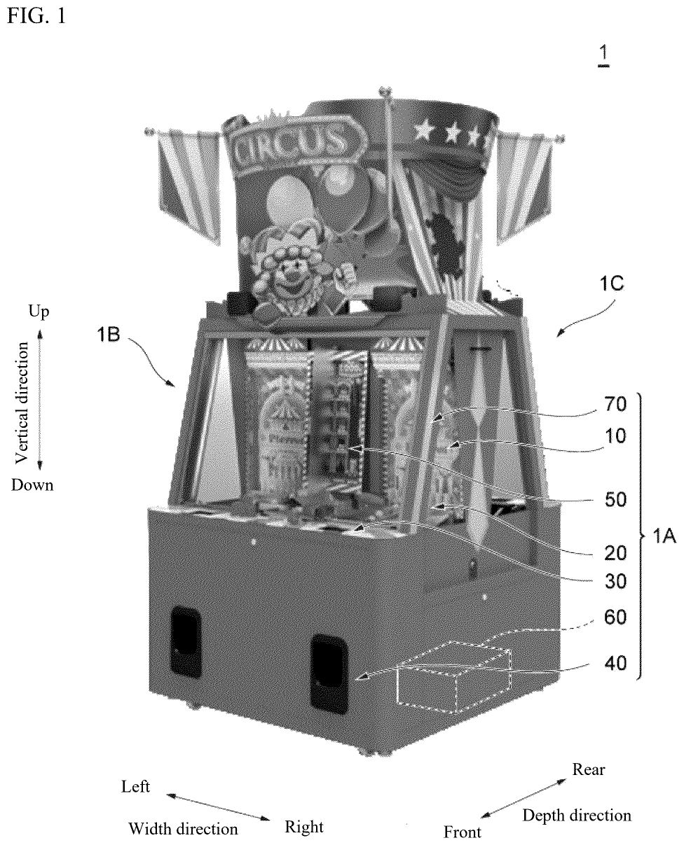

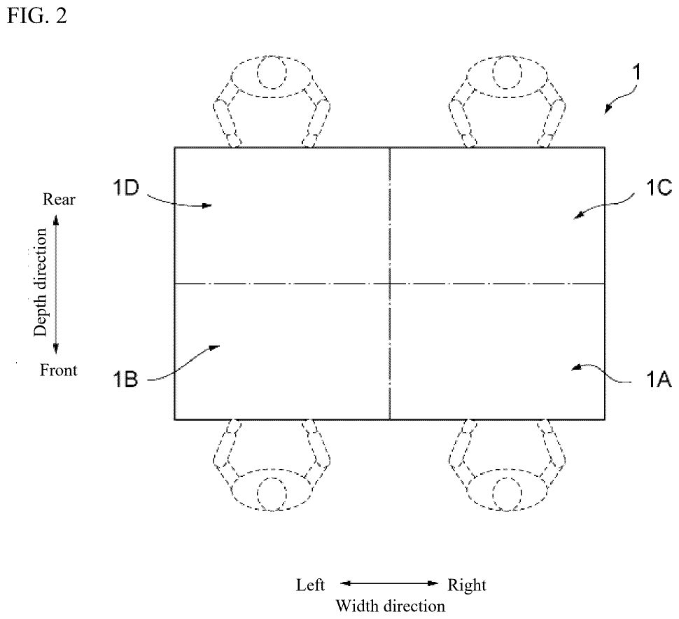

First, with reference to FIG. 1 and FIG. 2, a summary of the configuration of a lottery game machine 1 according to one or more embodiments and a lottery game performed by the lottery game machine 1 will be described. FIG. 1 is a perspective view illustrating a configuration of the lottery game machine 1. FIG. 2 is a schematic diagram illustrating the lottery game machine 1 in use.

The lottery game machine 1 according to one or more embodiments is one example of a game device in which a plurality of players can simultaneously play their own lottery games. Here, the lottery game, for example, includes a Corinth game played in a first lottery game unit 10 described later, and a Pusher game played in a second lottery game unit 20 described later. The Corinth game is played using a ball, which is one example of a play medium for the Corinth game. Note that the play medium for the Corinth game may be something other than a ball, such as a medal or a cube or the like, and may include two or more types of play media. The Pusher game includes a Ball Pusher game played using a ball and a Medal Pusher game played using medals. The Ball Pusher game and the Medal Pusher game are played simultaneously. The Corinth game can be played simultaneously with the Pusher game.

The lottery game machine 1 is a lottery device for four players. As illustrated in FIG. 2, the lottery game machine 1 includes game devices 1A to 1D. Each of the game devices 1A to ID has the same configuration. Therefore, by changing the number of game devices constituting the lottery game machine 1, the number of players who can utilize the lottery game machine 1 can be changed to numbers other than just one or four. In the following description, the configuration of the game device 1A will be mainly described.

### <Details of Game Device 1A>

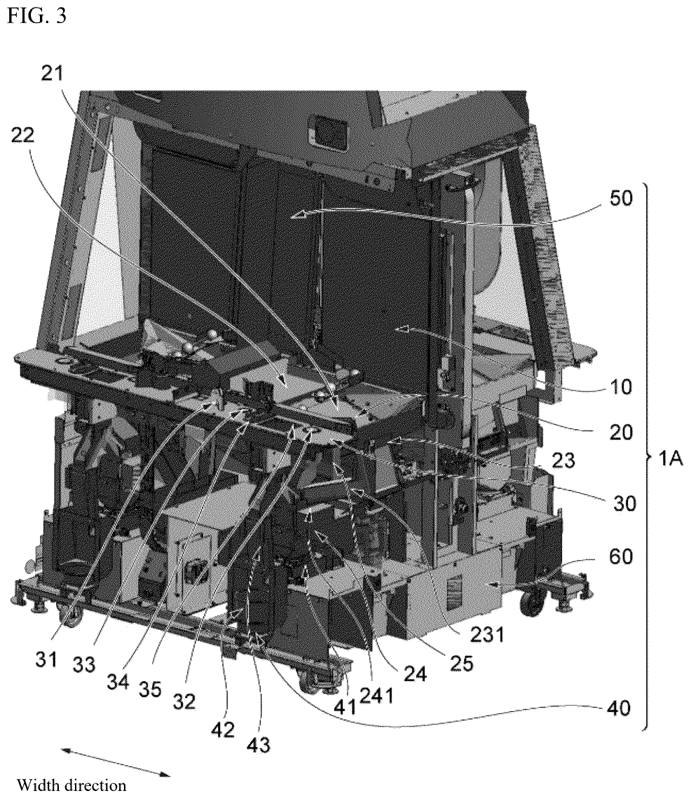

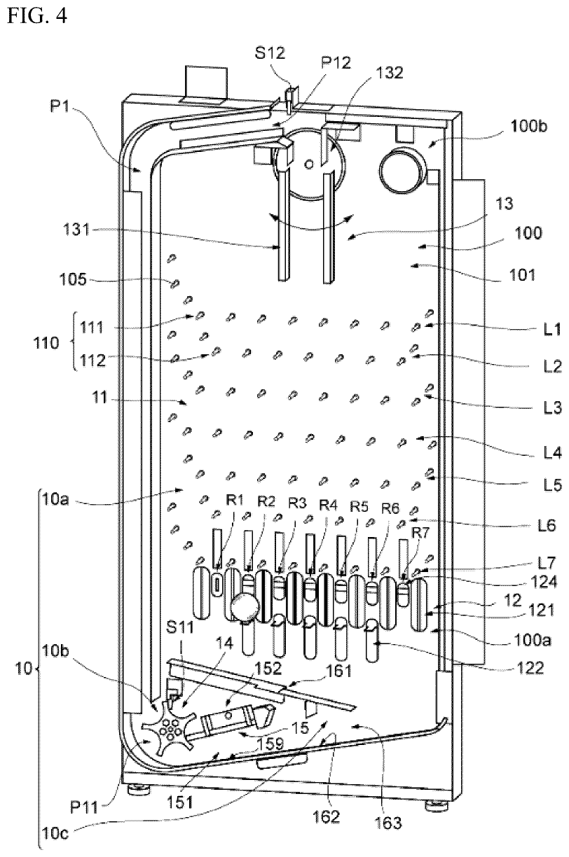

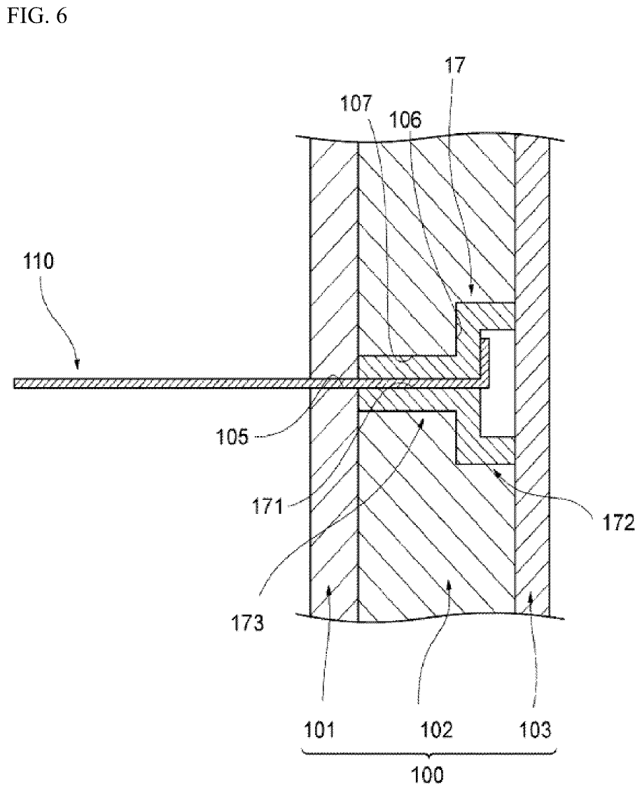

next, important components of the game device 1A according to one or more embodiments will be described in detail with reference to FIG. 1 to FIG. 16. FIG. 3 is a perspective view illustrating the internal structure of the lottery game machine. FIG. 4 to FIG. 6 are diagrams illustrating the configuration of the first lottery game unit 10. FIG. 6 to FIG. 16 are diagrams illustrating the configuration of the second lottery game unit 20.

as illustrated in FIG. 1 and FIG. 3, game device 1A is provided with a first lottery game unit 10 that conducts the Corinth game, a second lottery game unit 20 that conducts the pusher game, an operation unit (or operation panel) 30 for accepting operations from the player, a medium dispenser 40 for dispensing a play result medium such as medals corresponding to the results of the lottery game to the player, a display device (or display) 50 for displaying information relating to the lottery game, a controller 60 that comprises a central processing unit (CPU) and for executing the lottery game by controlling the operation of each of the first lottery game unit 10, the second lottery game unit 20, the operation unit 30, the medium dispenser 40, and the display device 50, and a housing 70 for supporting or housing the abovementioned configuration.

As illustrated in FIG. 3, the first lottery game unit 10 and the display device 50 are disposed on the upper rear side of the second lottery game unit 20 and perpendicular to the upper surface of the second lottery game unit 20. Note that the first lottery game unit 10 and the display device 50 may be disposed at an angle or horizontally relative to the upper surface of the second lottery game unit 20. The operation unit 30 and the medium dispenser 40 are attached to the housing 70. The display device 50 is disposed inside the housing 70.

### [First Lottery Game Unit 10]

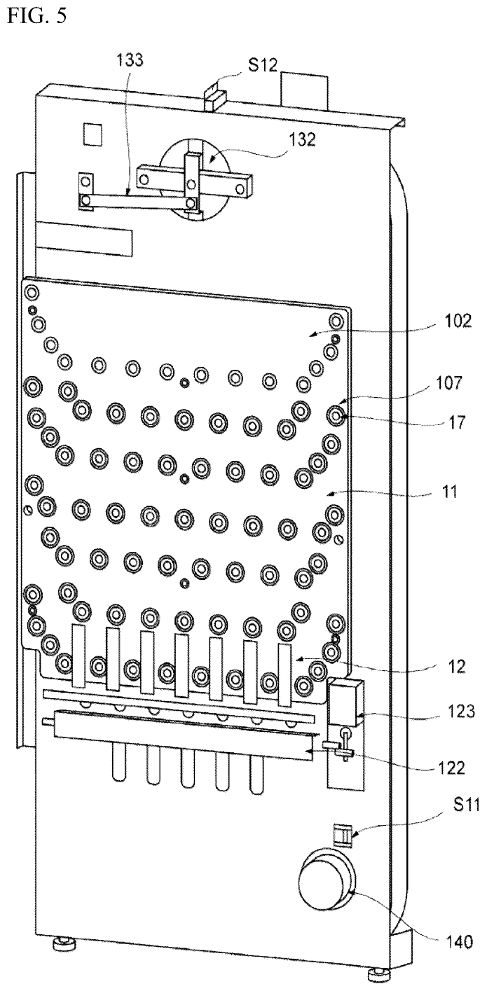

Next, the configuration of the first lottery game unit 10 will be described with reference to FIGS. 4 to 13. The first lottery game unit 10 is one example of a game device that conducts a game using a ball. As illustrated in FIG. 4 and FIG. 5, the first lottery game unit 10 is provided with a play field 10a in which the first lottery game is played using balls, a supplier 10b that supplies balls for the first lottery game to the play field 10a, and a storage 10c that stores balls that are discharged (fall) from the play field 10a and allows the stored balls to move toward the supplier 10b. Below, the details of each component of the first lottery game unit 10 will be described in the order of the play field 10a, the storage 10c, and the supplier 10b.

[Play Field 10a]

The play field 10a is provided a play board 11 having a base 100 and a plurality of guide pins 110 provided on the base 100, a receiving unit 12 provided on a first end 100a side of the base 100, and an insertion unit 13 provided on the second end 100b side of the base 100 for inserting a ball toward the plurality of guide pins 110 so that the ball reaches the receiving unit 12.

### (Base 100)

As illustrated in FIG. 4 to FIG. 6, the base 100 has a decorative plate 101 on which information about the Corinth game is printed, an attachment plate 102 for attaching a guide pin 110 provided on the back surface of the decorative plate 101, and a cover 103 for fixing the guide pin 110 attached to the attachment plate 102. The decorative plate 101 is provided with a plurality of holes 105 for passing the guide pins 110 therethrough, and the attachment plate 102 is provided with a plurality of holes 107 for attaching the guide pins 110 therethrough. As illustrated in FIG. 6, the hole 107 has a step part 106.

### (Guide Pin 110)

The guide pin 110 is a component for changing movement of a ball while causing the ball to bounce, which is one example of a play medium, by coming into contacting the ball. The guide pin 110 is made of, for example, a metal material. As illustrated in FIG. 6, the guide pin 110 is attached to the base 100 via the attachment part 17 without being in direct contact with the base 100.

Here, the attachment part 17 is made of a material, such as resin or the like, that has a lower hardness than the guide pin 110. By using this type of attachment part 17, it is possible to absorb vibrations of the guide pin 110 compared to attaching the guide pin 110 directly to the base 100, and by using a material that is less hard than the material of the base 100, it is possible to reduce the risk of the attachment part 17 vibrating and wearing down the base 100. As a result, the orientation and attaching precision of the guide pin 110 relative to the base 100 can be easily maintained.

The attachment part 17 has a retaining hole 171, a large diameter part 172, and a small diameter part 173. The guide pin 110 is attached to the retaining hole 171 and thereby fixed integrally with the attachment part 17. The position of the integrated guide pin 110 and attachment part 17 relative to the base 100 is fixed, with the large diameter part 172 being sandwiched between the step part 106 of the hole 107 of the attachment plate 102 and the cover 103. In this way, vibrations of the guide pin 110 can be absorbed, and the orientation and attaching precision of the guide pin 110 relative to the base 100 can be easily maintained.

As illustrated in FIG. 4, the guide pins 110 are provided on the base 100 in a plurality of rows along the longitudinal direction of the base 100. In the example illustrated in FIG. 4, the plurality of rows is seven rows, from a first row L1 to a seventh row L7. Moreover, the longitudinal direction of the base 100 is one example of a predetermined direction of the base 100. The predetermined direction may be a direction other than the longitudinal direction depending on the arrangement of the base 100 and the change in the shape of the base 100.

The plurality of guide pins 110 are configured so that the elasticity of at least one guide pin will be different from the elasticity of the other guide pins, and/or at least one inter-row distance between the rows will be different from the other inter-row distances to change and adjust the movement of the balls. Here, the greater the elasticity of the guide pin, the greater the force (bouncing force) applied to the balls that come into contact with the guide pin. As a result, the balls will bounce a long distance. Conversely, when the elasticity of the guide pin is small, the force (bouncing force) applied to the balls that come in contact with the guide pin is small. As a result, the distance the balls bounce is short. Moreover, the greater the inter-row distance, the less restriction there is on the ball bouncing range. As a result, the balls will bounce a long range. Conversely, when the inter-row distance is small, there is a more restriction on the ball bouncing range. As a result, the balls will bounce a short range.

Here, the elasticity of the guide pins 110 may be made different by various methods. For example, the guide pins 110 may be configured to have different diameters (that is, thicknesses). In this case, the larger the diameter, the less elastic the guide pins 110 become. In addition, for example, the guide pins 110 may be configured so that the material thereof may be changed. In this case, the greater the elasticity of the material that composes the guide pin 110, the greater the elasticity of the guide pin 110. Also, for example, the length of the portion of the guide pin 110 that protrudes from the base 100, that is, the length of the portion that is actually used during the game, may be configured to be different. In this case, the longer the length of the actually used portion of the guide pin 110, the more likely the guide pin 110 is to bend due to impact from the ball when it comes into contact with the ball, and the smaller the elasticity of the guide pin 110. Additionally, the guide pin 110 may be configured using a combination of some or all of these methods.

For example, the plurality of guide pins 110 include at least two types of guide pins: first guide pins 111 having a first elasticity and second guide pins 112 having a second elasticity larger than the first elasticity. Of the plurality of rows, the second guide pins 112 are arranged closer to the first end 100a side of the base 100 than the first guide pins 111. Additionally, of the plurality of rows, the number of rows defined by the second guide pins may be greater than the number of rows defined by the first guide pins.

In the example illustrated in FIG. 4, the first guide pins 111 form a first row L1 closest to the insertion unit 13, and the second guide pins 112 form a second row L2 to a seventh row L7. In this way, the player can easily insert balls into the target row between the guide pins 110.

Additionally, for example, of the plurality of inter-row distances formed by a plurality of rows, at least one inter-row distance is formed to be larger than the other inter-row distances. Furthermore, the distance between at least one of the rows may be formed closer to the first end 100a side than the second row L2, which is closer to the second end 100b side of the base 100.

In the example illustrated in FIG. 4, an inter-row distance between the first row L1 and the second row L2 is d1, and an inter-row distance between each of the second row L2 to the seventh row L7 is D2. Furthermore, the inter-row distance D1 is smaller than the inter-row distance D2. That is, among the plurality of inter-row distances formed by the plurality of rows, the inter-row distance closest to the insertion unit 13 is the smallest. In this way, by moving closer to the receiving unit 12, the bouncing range of the ball can be increased, the falling time of the ball can be extended, and the anticipation of the player with respect to the lottery game can be increased.

### (Insertion Unit 13)

The insertion unit 13 is one example of a configuration for balls to be inserted toward the plurality of guide pins 110 so that the balls will reach the receiving unit 12. As illustrated in FIG. 4 and FIG. 5, the insertion unit 13 has a tip part (or extending piece) 131, a support base 132 to which the tip part 131 is attached, and a drive unit (or driver) 133 for transmitting a driving force to the support base 132 to rotate the support base 132 back and forth in the direction illustrated in FIG. 4. The tip part 131 can rotate to input balls into each column of the guide pins 110 in the first row L1.

Furthermore, when defining a shortest distance between the tip part 131 and first row L1 as “l” and a diameter of the ball as “d,” “d” and “l” have the relationship d<l≤2d. With the insertion unit 13 positioned in this manner, the bouncing of the balls immediately after they are input from the insertion unit 13 can be suppressed, making it easier to input balls into the rows between the target guide pins 110.

### (Receiving Unit 12)

The receiving unit 12 is one example of a trigger for causing the lottery game to proceed by detecting balls. As illustrated in FIG. 4 and FIG. 5, the receiving unit 12 is provided below the plurality of guide pins 110 and above the housing portion 10c. Depending on the configuration of the plurality of guide pins 110, the receiving unit 12 may be provided within the area of the base 100 in which the plurality of guide pins 110 are provided, or may be provided above the plurality of guide pins 110. The receiving unit 12 has a guide plate 121 that defines seven columns R1 to R7, a ball support portion (or ball support) 122 that is movable up and down and is provided below columns R2 to R6, a ball sensor 124 that can detect the presence or absence of balls in each of the columns R1 to R7 or the path of balls, and a drive unit (or driver) 123 that drives the up and down movement of the ball support portion 122.

Each of the columns R1 to R7 is provided at a position corresponding in the up-down direction to each of the columns formed by the first guide pins 111 in the first row L1. When a lottery for the Corinth game is held, the ball support portion 122 is first positioned at the outlet of column R2 to column R6. When balls input through the insertion unit 13 enter the column R1 and the column R7, the balls pass through the column R1 and the column R7 and fall into the housing portion 10c. Conversely, when balls input by the insertion unit 13 enter the column R2 to column R6, the balls are supported by the ball support portion 122 so that they will be positioned within the column R2 to column R6.

Each of the plurality of ball sensors 124 can detect ball information of the balls received in each of the columns R1 to R7, for example, the presence or absence of balls that have passed through columns R1 and R7, the presence or absence of balls stored in each of columns R2 to R6, the number of balls stored in each of columns R2 to R6, differences in ball type (color and the like) and the like. In addition, when each of the plurality of ball sensors 124 detects ball information, it transmits the detected ball information to the controller 60, and under the control of the controller 60, the ball support portion 122 that is vertically movable and the lottery (physical lottery and program above) or other components of the game device 1A (for example, the second lottery game unit 20) can be operated.

The ball support portion 122, which is vertically movable, moves in the vertical direction under the control of the controller 60 to open and close the outlets of columns R2 to R6. Specifically, the controller 60 can initiate the downward movement of the ball support portion 122 based on the ball information in the columns R1 to R7 from the plurality of ball sensors 124. Here, for example, when the first ball enters any of the columns R2 to R6, each of the plurality of ball sensors 124 detects the passage of another ball through that column, and two balls stack in some or all of columns R2 to R6, the controller 60 determines whether the ball sensor 124 has entered the same column as a previous ball within the same game, and whether two balls are stacked when the ball sensor 124 continues to detect the ball. When any determination result is “YES,” the controller 60 can move the ball support portion 122 downward so that the ball stored in the field falls into the housing portion 10c.

[Storage 10c]

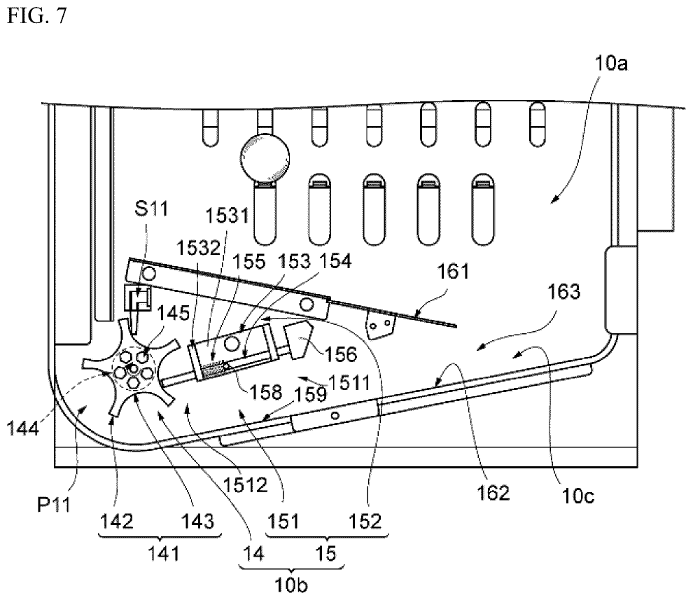

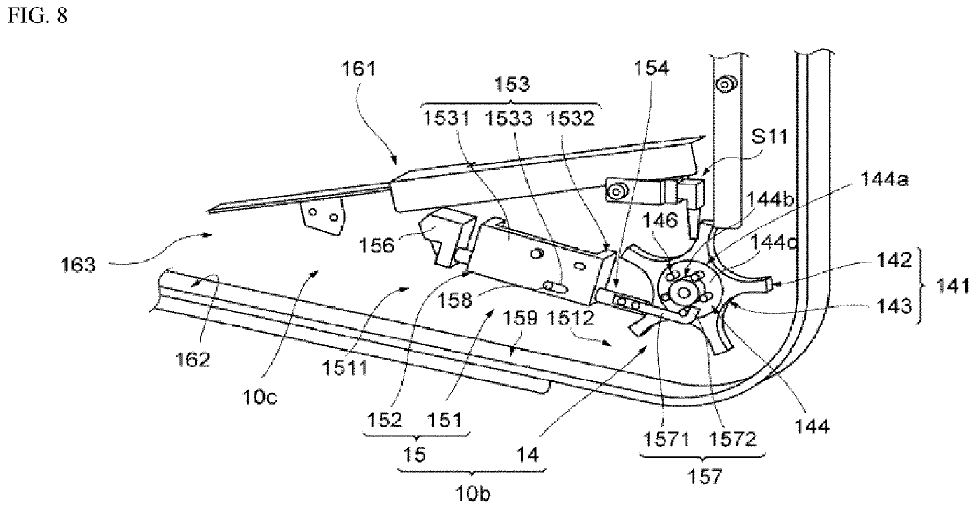

The storage 10c is one example of a configuration that temporarily stores balls discharged from the play field 10a. As illustrated in FIG. 4, FIG. 7, and FIG. 8, the storage 10c includes a first guide plate 161, a second guide plate 162, and a storage space 163 located between the first guide plate 161 and the second guide plate 162.

The first guide plate 161 is provided above the supplier 10b. The first guide plate 161 is configured to be extensible and retractable. Specifically, the first guide plate 161 can be adjusted within a range from a length corresponding to the columns R1 to R3 to a length corresponding to the columns R1 to R5. In this way, the first guide plate 161 can guide the balls that have fallen from the column corresponding to its length into the storage space 163 so that the balls do not collide directly with the components of the supplier 10b. Conversely, balls that fall from sections corresponding to the portions where the first guide plates 161 are not provided fall directly into the accommodation space 163 through the opening above the accommodation space 163.

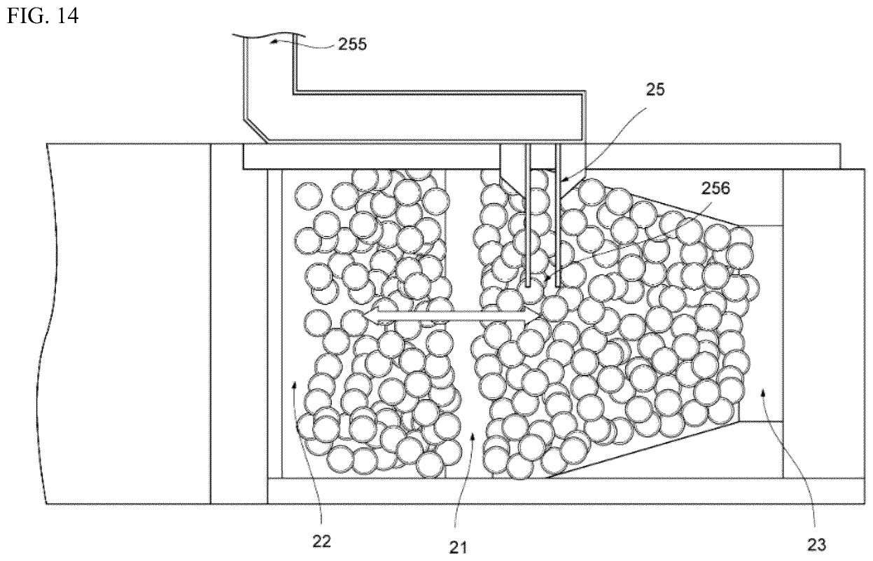

The second guide plate 162 is one example of a configuration that moves the balls contained in the containing space 163 toward the supplier 10b. As illustrated in FIG. 14, the second guide plate 162 is disposed at an angle to the horizontal direction so that the balls in the accommodation space 163 move forward to the supplier 10b by their own weight.

Note that a structure other than the second guide plate 162 may be adopted for the structure for moving the balls contained in the containing space 163 toward the supplier 10b. For example, a piston may be employed to push balls provided on a horizontally disposed ball support plate into the supplier 10b.

[Supplier 10b]

The supplier 10b is one example of a configuration for conveying balls to the play field 10a. As illustrated in FIG. 4 and FIG. 7, the supplier 10b is provided with a conveying unit 14 that conveys balls to the insertion unit 13 of the play field 10a and a ball guide 15 that guides balls from the storage 10c to the conveying unit 14 in succession.

Here, a conveyance path P1 is provided between the conveying unit 14 and the insertion unit 13 to connect them. As illustrated in FIG. 14, the conveyance path P1 has an entrance P11 on the conveying unit 14 side and an exit P12 located on the insertion unit 13 side. An exit sensor S12 is provided at the exit P12 of the conveyance path P1 to detect the presence or absence of balls at the exit P12. For example, when detecting that there is no ball at the exit P12, the exit sensor S12 transmits that information to the controller 60. When receiving a signal from the exit sensor S12, the controller 60 rotates the conveying unit 14.

### (Conveying Unit 14)

The conveying unit 14 is one example of a configuration that conveys balls one by one to the conveyance path P1. A ball first conveyed to the entrance P11 by the conveying unit 14 is pushed against a ball subsequently conveyed to the entrance P11, moves along the conveyance path P1, and is conveyed to the exit P12.

Furthermore, as illustrated in FIG. 7 and FIG. 8, the conveying unit 14 has a conveying plate 141, a drive unit (or driver) 140 for driving rotation of the conveying plate 141, an attachment unit (or mounting component) 144 attached to a back surface of the conveying plate 141 so as to transmit driving force from the drive unit 140 to the conveying plate 141, and five engagement units (or engagement parts) 145 attached to the conveying plate 141.

The conveying plate 141 has a star shape. The conveying plate 141 has five protrusions 142 and recesses 143 formed between two adjacent protrusions 142. The five protrusions 142 are provided at equal intervals on the periphery of the conveying plate 141. The length of each protrusion 142 is equal to or less than the radius of the ball. Each recess 143 has a shape corresponding to the outer shape of one ball so that it can hold one ball. Hereinafter, the position where the convey plate 141 starts to hold the ball via the recess 143 may be referred to as the “convey start position.”

An inlet sensor S11 is provided above the conveying plate 141 to detect whether the conveying plate 141 is rotating. For example, when the conveying plate 141 does not rotate due to damage, jamming, or the like of the conveying plate 141, the inlet sensor S11 detect this information and transmit it to the controller 60. The controller 60 can stop the rotation of the conveying unit 14 upon receiving a signal from the entrance sensor S11.

The attachment unit 144 has a cylindrical configuration with a step. The attachment unit 144 has, in its central axial direction, a large diameter portion 144a fixed to the conveying plate 141, a small diameter portion 144b fixed to the rotation shaft (not shown) of the drive unit 140, and a step surface 144c located between the large diameter portion 144a and the small diameter portion 144b. Such attachment unit 144 allows the driving force from the drive unit 140 to be transmitted to the conveying plate 141.

As illustrated in FIG. 7 and FIG. 8, the five engaging units 145 are fixed to the conveying plate 141 at positions corresponding to the five recesses 143. Each engaging unit 145 has an engaging end 146 that protrudes from the stepped surface 144c of the attachment unit 144. The engaging end 146 is configured to be able to engage with or separate from the ball guide 15.

The drive unit 140 operates under the control of the controller 60 to rotate the conveying plate 141. For example, when the controller 60 receives a signal from the player to throw a ball into the play field 10a or a signal from the exit sender S12 that there is no ball at the exit P12, the controller 60 can activate the drive unit 140 to rotate the conveying plate 141. Furthermore, the controller 60 may activate the drive unit 140 continuously or at regular time intervals so as to rotate the conveying plate 141 continuously or at regular time intervals.

Furthermore, the drive unit 140 drives operation of the ball guide 15 when the ball guide 15 is engaged with the engaging end 146. Conversely, when the ball guide 15 and the engaging end 146 are separated, the drive unit 140 does not drive the operation of the ball guide 15. (Ball Guide 15)

The ball guide 15 is one example of a configuration that realizes continuous guidance of the balls to the conveying unit 14. Here, “continuous guidance of balls” by the ball guide 15 means that when a plurality of balls are supplied from the storage 10c to the supplier 10b, the ball guide 15 guides the plurality of balls one by one from the storage 10c to the supplier 10b to the convey start position in sequence each time there is no ball at the convey start position of the conveying unit 14, so that the conveying unit 14 can convey the balls to the conveyance path P1 at any time. Furthermore, the absence of a ball at the convey start position is due to the storage 10c not supplying a ball to the supplier 10b or the conveying unit 14 conveying a ball at the convey start position to the conveyance path P1. Furthermore, when the conveying unit 14 conveys one ball at the convey start position to the conveyance path P1, the ball guide 15 guides another ball to the convey start position of the conveying unit 14 at the same time.

Furthermore, as illustrated in FIG. 7 and FIG. 8, the ball guide 15 is disposed below the first guide plate 161 and near the conveying unit 14. The ball guide 15 has a guide path 151 that passes the balls from the storage 10c one by one toward the conveying unit 14, and an adjuster 152 that moves at least one of the stacked balls to another position in the storage 10c when balls near an entrance 1511 on the storage 10c side of the guide path 151, which will be described later, are stacked above the height of the entrance 1511.

The guide path 151 is one example of a configuration that connects the storage 10c and the conveying unit 14. As illustrated in FIG. 7 and FIG. 8, the guide path 151 is a space defined by an adjuster 152 and a guide plate 159 provided at a position opposite the adjuster 152. The guide plate 159 is one example of a wall portion that supports the balls and supplies them to the transfer start position of the conveying unit 14. The guide plate 159 is disposed at an angle relative to the horizontal direction so that the balls from the storage 10c move forward toward the conveying unit 14 by their own weight. The guide plate 159 is connected to a second guide plate 162 of the storage 10c.

Furthermore, as illustrated in FIG. 7 and FIG. 8, the guide path 151 has an entrance 1511 located on the side of the storage 10c and an exit 1512 located on the side of the conveying unit 14. The entrance 1511 is formed to allow the balls from the storage 10c to enter the guide path 151 one by one. The exit 1512 is formed so as to discharge the balls in the guide path 151 one by one into the conveying unit 14. Furthermore, the guide path 151 is configured to, before a plurality of balls sequentially enter the entrance 1511 from the storage 10c and are discharged from the exit 1512, align the balls in one row in which adjacent balls are in contact with each other.

Here, the guide path 151 can align one row including, for example, three balls. The one row is supported by a guide plate 159 and can move by its own weight along the guide plate 159 to a conveyance start position of the conveying unit 14. Due to one row being supported by such guide plate 159, the conveying unit 14 conveys the first ball in that row to the conveyance path P1, and at the same time, the second ball can move by its own weight along the guide plate 159 to the convey start position. Similarly, thereafter, the conveying unit 14 conveys the second ball to the conveyance path P1, and at the same time, the third ball can move by its own weight along the guide plate 159 to the convey start position. As a result, the balls in one row are guided one by one successively to the convey start position by the guide plate 159, and the conveying unit 14 can convey the ball that is at the convey start position to the conveyance path P1 at any point in time.

The adjuster 152 is one example of a configuration for eliminating stacking of balls near the entrance 1511 of the guide path 151 in the storage 10c. When balls near the entrance 1511 of the guide path 151 are piled up in two or more layers exceeding the height of the entrance 1511, the adjuster 152 moves at least one of the balls in the second layer to another position in the storage 10c. In addition, by changing the installation position, size, configuration, and the like of the adjuster 152, the adjuster 152 may be configured to move the positions of balls in other layers of balls stacked in two or more layers, or of balls in multiple layers.

Furthermore, the adjuster 152 may have a piston that pushes the ball in a direction away from the entrance 1511. Specifically, as illustrated in FIG. 7 and FIG. 8, the adjuster 152 has a base body 153, a piston pin 154 attached to the base body 153 so as to be able to move back and forth, and a compression spring 155 provided between the base body 153 and the piston pin 154.

As illustrated in FIG. 7 and FIG. 8, the base body 153 has a fixed portion 1531 fixed to the base 100, two support portions 1532 that support the piston pin 154, and a long hole 1533 provided in the fixed portion 1531.

As illustrated in FIG. 7 and FIG. 8, the piston pin 154 includes a push block 156 at one end of the piston pin 154, an engaging unit 157 at the other end of the piston pin 154, and a pin 158 that limits the range of movement of the piston pin 154.

The pin 158 is provided on piston pin 154 in the radial direction of piston pin 154 so that both ends protrude from the surface of piston pin 154. One end of the pin 158 is slidably inserted into the long hole 1533 of the base body 153. Thus, the range of reciprocating movement of the piston pin 154 is limited by the long hole 1533. The compression spring 155 is provided between the other end of the pin 158 and a support portion 1532 on the conveying unit 14 side. Due to such compression spring 155, when the compression spring 155 is not compressed, the piston pin 154 is supported by the compression spring 155 and stops at a standby position, while when the compression spring 155 is compressed and returns to its original length, the piston pin 154 receives elastic force from the compression spring 155 and can perform reciprocating movement (piston operation).

The push block 156 is one example of a configuration for adjusting the contact position and pushing direction between the piston pin 154 and the ball when the piston pin 154 performs a piston action. The push block 156 is pentagonal. Due to such push block 156, when the piston pin 154 is pushed out, it comes into contact with a position corresponding to the center of gravity of one of the stacked balls in the second layer that is located closest to the entrance 1511, and can push that ball downward in a direction away from the entrance 1511. The push block 156 may have a shape other than a pentagon depending on the characteristics of the ball, such as the size, material, and weight. The push block 156 may also push the ball upward away from the entrance 1511 or in a direction parallel to the direction away.

The engaging unit 157 is L-shaped. As illustrated in FIG. 8, the engaging unit 157 has a first part 1571 and a second part 1572. The engaging unit 157 can be engaged with and then separated from the five engaging ends 146 of the conveying unit 14 in sequence due to the rotation of the conveying plate 141 causing the positions of the five engaging ends 146 to fluctuate. By such engagement between the engaging unit 157 and the engaging end 146 of the conveying plate 141, the piston pin 154 is driven by the drive unit 140 of the conveying unit 14. The details of the engagement and separation between the engaging unit 157 and the five engaging ends 146 of the conveying unit 14 will be explained in detail in the section “Conveyance and Adjustment of Balls by the Supplier 10b” below.

In the above description, the piston pin 154 is described as being driven by the drive unit 140 of the conveying unit 14 through engagement between the engaging unit 157 and the engaging end 146 of the conveying plate 141, but such is not limited thereto. The piston pin 154 may be driven by a dedicated drive for the piston pin 154, for example, to perform piston movements at regular intervals. Also, the piston pin 154 may be driven by the weight of the stacked balls, for example, when the balls are stacked. In this case, for example, a dedicated drive unit for the piston pin 154 is provided with an actuation mechanism for actuating the dedicated drive unit.

When the weight of the stacked balls presses against the actuation mechanism, a dedicated drive unit of the piston pin 154 can be actuated to cause the piston pin 154 to perform a piston movement. Furthermore, the piston pin 154 may, for example, be driven by a dedicated drive unit for the piston pin 154 only when the balls are stacked on the entrance 1511 side of the guide path 151. In this case, for example, a stacking detection sensor is provided on the entrance 1511 side of the guide path 151 to detect whether or not balls are stacked on the entrance 1511 side of the guide path 151. In this way, when detecting that balls are stacked on the entrance 1511 side of the guide path 151, the stacking detection sensor transmits a signal to the controller 60. Then, based on the signal from the stacking detection sensor, the controller 60 activates a dedicated drive unit for the piston pin 154 so as to cause the piston pin 154 to perform a piston movement.

[Conveyance and Adjustment of Balls by Supplier 10b]

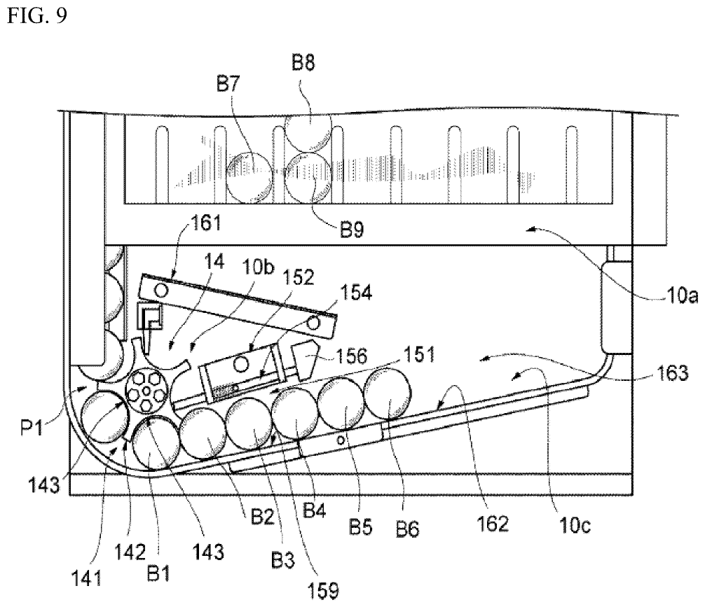

Next, the conveyance and adjustment of balls by the supplier 10b will be described using the examples illustrated in FIG. 9 to FIG. 13. In this example, as illustrated in FIG. 9, the guide path 151 already aligns one row formed by balls B2 to B4. The receiving unit 10c also receives balls B5 and B6. Hereinafter, a layer on the balls B5 and B6 supported by the second guide plate 162 may be referred to as the “first layer.”

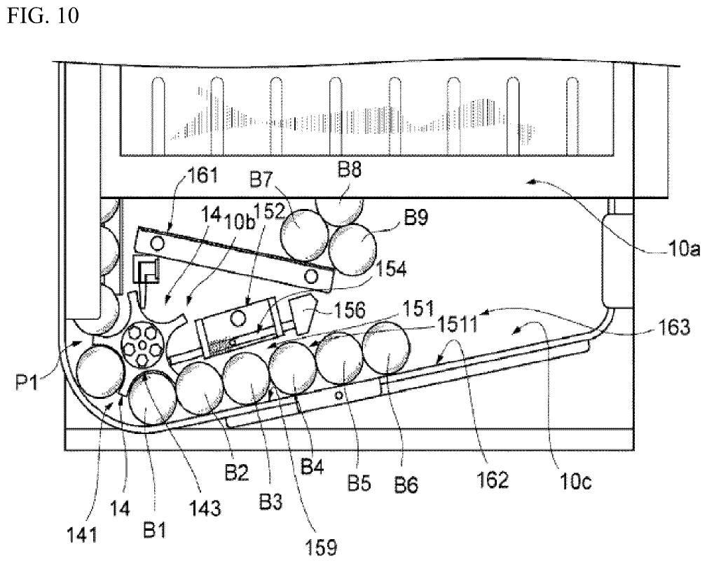

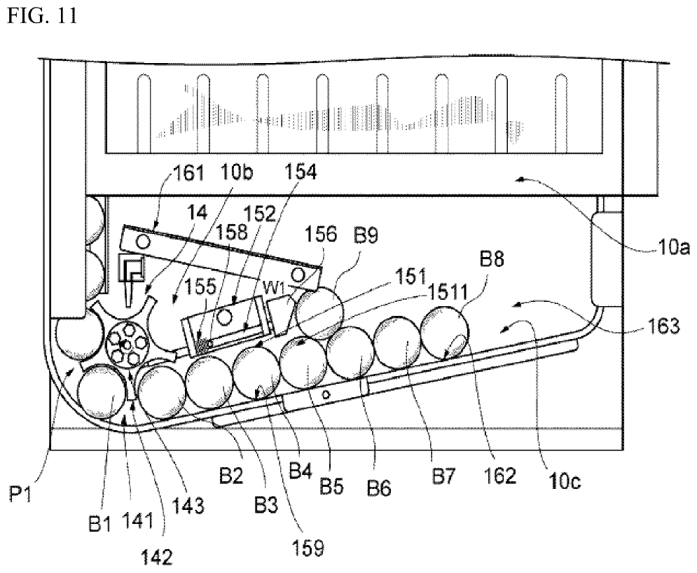

When the lottery game in the play field 10a is over, balls B7 to B9 in the play field 10a fall into the storage 10c, as illustrated in FIG. 9 and FIG. 10. At this time, the balls B5 and B6 are already stored in the storage 10c, and thus the ball B9, one of the newly dropped balls, stacks onto the first layer of balls to form a second layer of balls, as illustrated in FIG. 11.

At this time, when the conveying plate 141 starts to rotate based on the control of the controller 60, the conveying plate 141 conveys the ball B1 held in the first recess 143 to the conveying path P1. At the same time that the conveying plate 141 conveys the ball B1, the guide plate 159 of the adjuster 152 supplies the ball B2 to the second recess 143 of the conveying plate 141. In this way, the problem of ball jamming caused by the engagement of the protrusion 142 of the convey plate 141 with the ball B2, which occurs when the ball B2 is supplied to the convey plate 141 after the convey of the ball B1 by the convey plate 141, can be solved.

At the same time that the convey plate 141 conveys the ball B1, the engaging end 146 provided at a position corresponding to the second recess 143 engages with the engaging unit 157 of the piston pin 154 of the adjuster 152. At this time, as illustrated in FIG. 11, the compression spring 155 of the adjuster 152 is compressed by the force from the conveying plate 141, and the piston pin 154 moves to a first position W1 which is closer to the conveying unit 14 than the standby position.

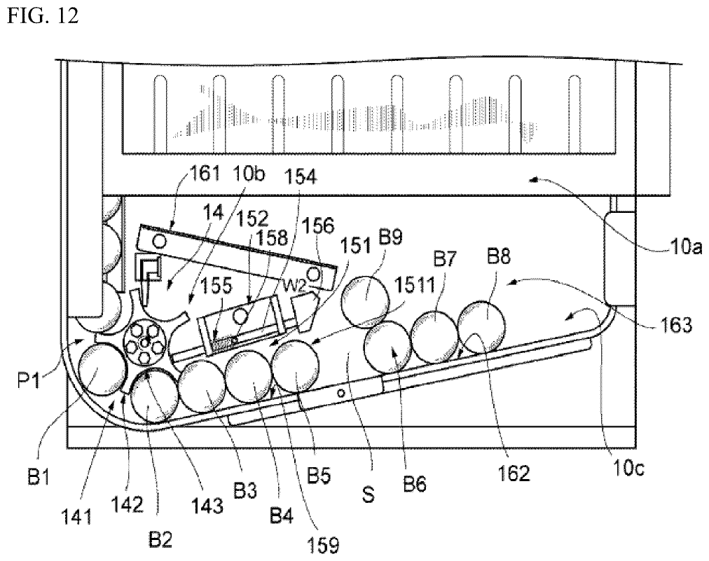

Then, as the conveying plate 141 continues to rotate, the ball B2 held by the second recess 143 is conveyed toward the conveying path pl, and the engaging end 146 slides along the second part 1572 (see FIG. 8) of the engaging unit 157 of the piston pin 154 and then slides out from the second part 1572. At this time, engagement between the engaging end 146 and the engaging unit 157, that is, engagement between the adjuster 152 and the conveying unit 14, is released. As the engaging end 146 and the engaging unit 157 separate, the compressed compression spring 155, as illustrated in FIG. 12, is no longer subjected to force from the conveying plate 141 and expands in the direction opposite to the direction in which it was compressed, returning to its original length. During this process, the piston pin 154 receives elastic force from the compression spring 155 in the direction opposite to the direction in which it was compressed, and is pushed out in the opposite direction, moving to a second position W2 which is closer to the storage 10c than the standby position. By this movement, the push block 156 of the piston pin 154 pushes the ball B9 in the second layer in a direction away from the entrance 1511 of the guide path 151. Also, as illustrated in FIG. 12, due to the ball B9 moving, the balls B6 to B8 in the first layer are also moved away from entrance 1511 by the force of the ball B9, and a space S is formed between the ball B5 and the ball B6.

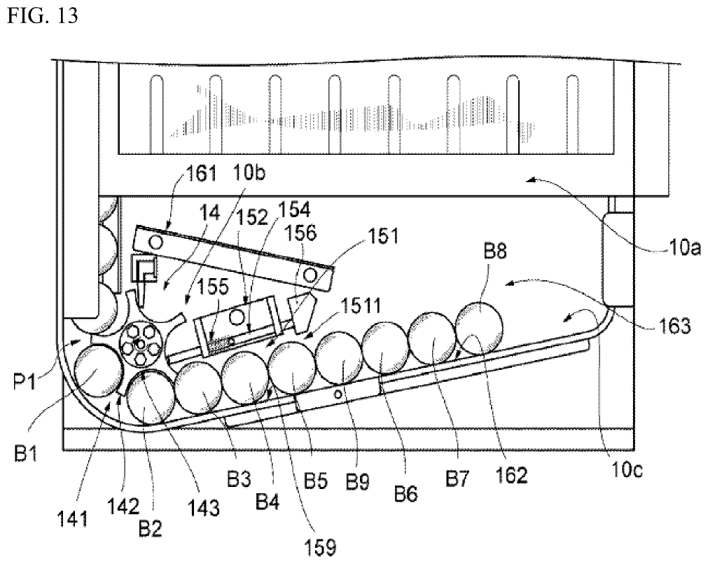

Then, as illustrated in FIG. 13, after the piston pin 154 returns from the second position w2 to the standby position and before the engaging unit 157 of the piston pin 154 engages with the next engaging end 146, the piston pin 154 stops at the standby position. In this case, the ball B9 falls into the space S, and the balls B6 to B8 move toward the ball B9. As a result, as illustrated in FIG. 13, all the balls in the supplier 10b and the storage 10c were aligned in a row in approximately one layer. In other words, the piston pin 154 eliminates the stacking of the balls on the entrance 1511 side of the guide path 151, thereby preventing the balls from getting jammed between the ball movement paths, that is, between the first guide plate 161 and the second guide plate 162, due to the stacking of the balls.

Furthermore, as the conveying plate 141 continues to rotate, the engaging unit 157 (see FIG. 8) of the piston pin 154 engages with the other engaging ends 146 in sequence, and the piston pin 154 repeats the adjustment described above to the ball by engaging the piston pin 154 with the first engaging end 146 and separating such. In this way, the piston pin 154 can perform piston movement at regular intervals by engaging and separating the engaging unit 157 with the five engaging ends 146 of the conveying unit 14.

### [Second Lottery Game Unit 20]

Next, the configuration of the second lottery game unit 20 will be described with reference to FIGS. 3 and 7 to 9. As illustrated in FIG. 3 and FIG. 14, the second lottery game unit 20 includes a placement surface 21 on which medals and balls are placed, a pusher table 22 that moves the medals and balls placed on the placement surface 21, a drop port 23 through which the medals and balls that are placed on the placement surface 21 will drop, a medal supplier 24 that supplies the medals to the placement surface 21, and a ball supplier 25 that supplies the balls to the placement surface 21.

### (Placement Surface 21)

The placement surface 21 is configured to be used for the Pusher game. As illustrated in FIG. 3, the placement surface 21 is provided so that its longitudinal direction coincides with the width direction of the game device 1A. Furthermore, the placement surface 21 allows for medals supplied by the medal supplier 24 and balls supplied by the ball supplier 25 to be placed thereon.

### (Pusher Table 22)

The pusher table 22 is configured to be used in the Medal Pusher game and the Ball Pusher game. The pusher table 22 is provided above the placement surface 21 and at one end side of the placement surface 21 in the longitudinal direction. Furthermore, under the control of the controller 60, the pusher table 22 can move horizontally back and forth in the direction along the longitudinal direction of the placement surface 21 as indicated by the arrow in FIG. 14.

### (Drop Port 23)

The drop port 23 is configured to be used for the Pusher game. The drop port 23 is provided on the other end side of the placement surface 21 in the longitudinal direction. The medals and balls pushed by the pusher table 22 can fall from the placement surface 21 through the drop port 23. The drop port 23 has a collection path 231 that guides the movement of the dropped medals and balls. The collection path 231 is connected to the medal supplier 24 and the ball supplier 25.

### (Medal Supplier 24)

The medal supplier 24 is configured to supply medals for the Medal Pusher game to the placement surface 21. As illustrated in FIG. 3, the medal supplier 24 has a medal housing portion 241 and a conveying unit 242 that conveys the medals in the medal housing portion 241 to the placement surface 21. The medals dropped from the drop port 23 are conveyed to the medal housing portion 241 via a collection path 231.

### (Ball Supplier 25)

The ball supplier 25 is configured to supply balls for the Ball Pusher game to the placement surface 21. As illustrated in FIG. 3 and FIG. 7 to FIG. 9, the ball supplier 25 has a spiral conveying lift 251 and a guide passage 252, which guides balls conveyed from the conveying lift 251 to a position on the placement surface 21 where the ball does not interfere with the moving range of the pusher table 22.

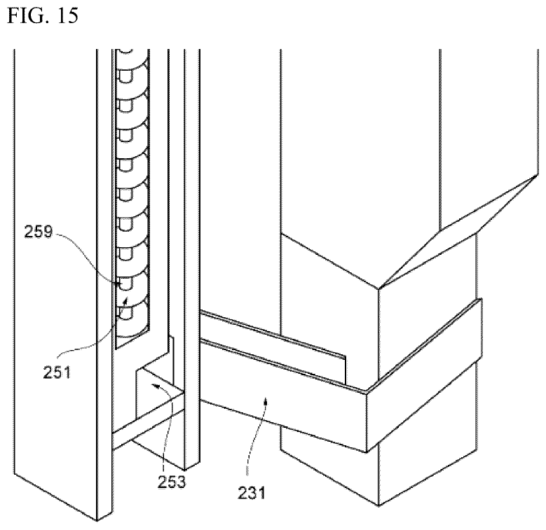

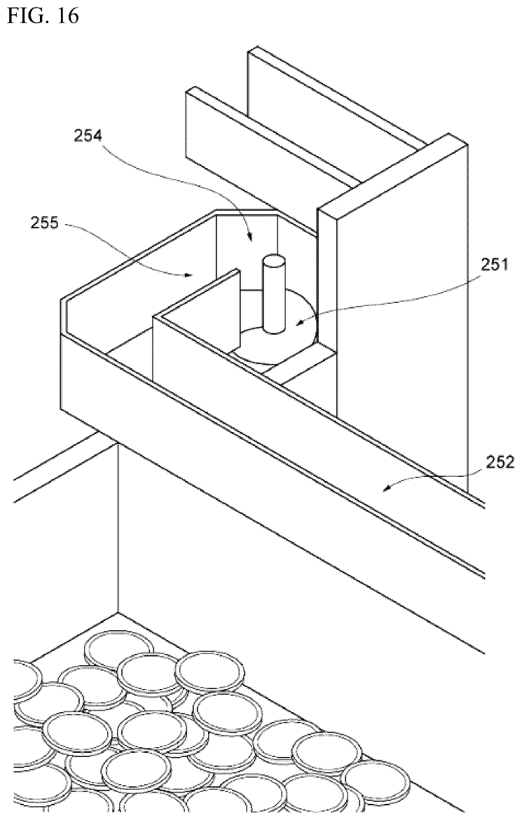

As illustrated in FIG. 15 and FIG. 16, the conveying lift 251 has a conveyance inlet 253 on its lower side and a conveyance outlet 254 on its upper side. The conveying lift 251 can convey balls at the conveyance inlet 253 to the conveyance outlet 254 by rotating around a central axis 259. In addition, the conveyance inlet 253 is directly connected to the collection path 231.

Therefore, the balls that drop from the drop port 23 are conveyed via the collection path 231 directly to the conveyance inlet 253 located below the conveying lift 251, and then conveyed directly to the conveyance inlet 253 by the conveying lift 251.

as illustrated in FIG. 14 and FIG. 16, the guide passage 252 has one end 255 and another end 256. The one end 255 is connected to the conveyance inlet 253. The other end 256 is disposed above the placement surface 21 so that the balls can fall at a position on the placement surface 21 that does not interfere with the moving range of the pusher table 22. In this way, the balls conveyed from the conveyance inlet 253 enter the one end 255 and then can be supplied to the placement surface 21 from the other end 256 without colliding with the upper surface of the pusher table 22.

### [Operation Unit 30]

The operation unit 30 is configured to receive various operations from the player. As illustrated in FIG. 3, the operation unit 30 includes a first operation unit 31 that may include a control stick and is operated to control the rotation direction of the insertion unit 13, a second operation unit 32 that may include a button and is operated to input balls into the play board 11 via the insertion unit 13, a third operation unit 33 that may include a button and is operated to pay out medals corresponding to the result of the lottery game, a starting medium receiving unit 34 that may include an input slot and receives medals, which are one example of a play starting medium, from the player for starting the lottery game, and a money bowl 35 on which the player places medals and the like retained by the player.

### [Medium Dispenser 40]

The medium dispenser 40 is configured to dispense medals, which are one example of a play result medium, to the player, corresponding to the result of the lottery game played by the player. As illustrated in FIG. 3, the medium dispenser 40 includes a housing portion 41 for storing medals inserted by a player and medals to be paid out to a player, a dispensing outlet 42, and a conveying unit 43 for conveying the medals stored in the housing portion 41 to the dispensing outlet 42.

Here, the medals circulating between the starting medium receiving unit 34 and the medium dispenser 40 as well as the medals used in the Medal Pusher game described above are in different circulation systems. In other words, the medals used in the Pusher game are not paid out to the player. In addition, the circulation systems for the balls used in the Corinth game and the balls used in the Ball Pusher game are independent of each other.

### [Display Device 50]

The display device 50 is configured to display various game contents, game information relating to the lottery game, and the like. The game content of one or more embodiments includes display of a portion of the Medal Pusher game, and the like, and the game information of one or more embodiments includes, for example, the number of medals inserted by the player into the starting medium receiving unit 34 and any changes in that number as well as information on the number of medals paid out, and the like.

### [Control by Controller 60]

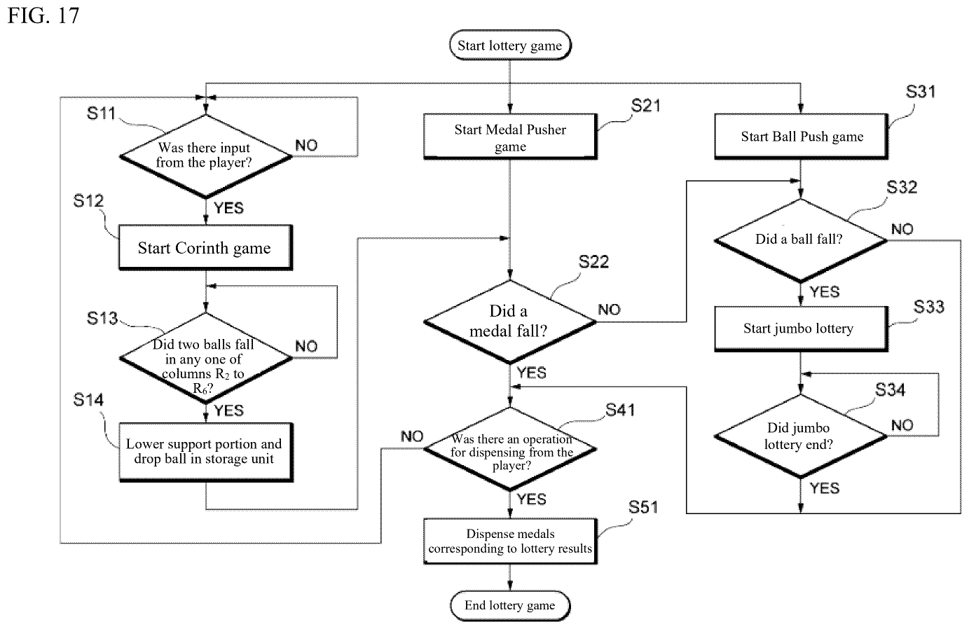

Next, with reference to FIG. 17, a detailed description will be given of one example of control by the controller 60, that is, a process related to the lottery game performed by the controller 60 based on the data and programs stored in the memory. Depending on the settings, the controller 60 can perform processes relating to different lottery games. FIG. 17 is a flowchart for explaining the control of the lottery game by the controller 60.

### (Steps S11, S21, and S31)

First, the controller 60 starts the Medal Pusher game and the Ball Pusher game via the second lottery game unit 20 (steps S21, S31), and determines whether there is an input from the player to start the Corinth game (step S11).

### (Steps S13, S14, and S22)

When there is an input from the player to start the Corinth game (YES in step S11), the controller 60 starts the Corinth game via the first lottery game unit 10 (step S12). Next, the controller 60 determines whether two balls have entered any one of the columns R2 to R6 of the receiving unit 12 of the first lottery game unit 10 (step S13). When two balls enter any one of the columns R2 to R6 of the receiving unit 12 (YES in step S13), the controller 60 lowers the ball support portion 122 to drop the balls into the housing portion 10c (step S14), and then pays out medals to the medium dispenser 40 depending on the ball storage status in each column before the balls were dropped (for example, the number of balls lined up in each column). Thereafter, the controller 60 determines whether any medal has fallen into the drop port 23 by being pushed by the pusher table 22 in the Medal Pusher game while it is ongoing (step S22).

Here, in one or more embodiments, the controller 60 has been described as initiating a physical lottery for the lottery game based on the storage state of the balls actually stored in the receiving unit 12, but it is not limited to this. For example, the controller 60 may, alternatively, perform a non-physical lottery (programmed lottery) based on a pre-stored program, without relying on the storage state of the balls in the receiving unit 12. In this case, the controller 60 can start a lottery in which the number of medals to be paid out varies depending on the column into which the ball falls, for example. Specifically, the controller 60 can dispense a maximum of 100 medals when a ball enters the column R4 and dispense a maximum of 500 medals when a ball enters the column R2. Additionally, the controller 60 can start a lottery to determine the number of medals to be paid out, for example, on the condition that two balls stack in any of the columns. Specifically, the controller 60 can start a lottery for a maximum of 100 medals when three of the columns R2 to R6 have balls in them and can start a lottery for a maximum of 500 medals when four of the columns R2 to R6 have balls in them.

### (Steps S32 and S33)

When no medals have fallen into the drop port 23 (NO in step S22), the controller 60 determines whether any balls have fallen into the drop port 23 as a result of being pressed by the pusher table 22 in the ongoing Ball Pusher game (step S32). When there are any dropped balls in the drop port 23 (YES in step S32), the controller 60 starts a jumbo lottery (step S33).

Here, the jumbo lottery performed in step S33 is the same lottery game as the Corinth game performed in steps S11 to S14, but the only difference is the number of medals to be paid out corresponding to the lottery result. For this reason, a detailed explanation of the jumbo lottery will be omitted. Alternatively, the jumbo lottery may be a lottery game other than the Corinth game.

### (Steps S34, S41, and S51)

Next, the controller 60 determines whether the jumbo lottery has ended (step S34). When the jumbo lottery has ended (YES in step S34), the controller 60 determines whether the player has performed an operation to dispense medals (step S41). When the operation to dispense medals is performed by the player (YES in step S41), the controller 60 pays out to the dispensing outlet 42 a number of medals corresponding to both the lottery result of the Corinth game and the ball lottery result of the Ball Pusher game, that is, the lottery result of the jumbo lottery (step S51), after which the lottery game will end.

Conversely, when there is no input from the player to start the Corinth game (NO in step S11), the controller 60 returns the process to step S11. When two balls are not in any one of the columns R2 to R6 of the receiving unit 12 (NO in step S13), the controller 60 returns the process to step S13.

Conversely, when there are medals dropped into the drop port 23 (YES in step S22), the controller 60 advances the process to step S41, and determines whether the player has performed the operation to dispense medals (step S41). In this case, when the operation to dispense medals is performed by the player (YES in step S41), the controller 60 pays out to the dispensing outlet 42 a number of medals corresponding to the lottery result of the Corinth game and the lottery result of the medal lottery and/or the ball lottery result of the Ball Pusher game (step S51), after which the lottery game will end.

Conversely, when no balls have fallen into the drop port 23 (NO in step S32), the controller 60 advances the process to step S41, and determines whether the player has performed the operation to dispense medals (step S41). In this case, when the operation to dispense medals is performed by the player (YES in step S41), the controller 60 pays out to the dispensing outlet 42 a number of medals corresponding to the lottery result of the Corinth game and the lottery result of the medal lottery (step S51), after which the lottery game will end.

Conversely, when there is no operation to dispense medals from the player (NO in step S41), the controller 60 returns the process to step S11. That is, when there is no operation for dispensing medals from the player, the controller 60 can repeatedly perform the Corinth game, the Medal Pusher game, and the Ball Pusher game.

The first lottery game unit 10 according to the embodiments described above is provided with: a play field 10a in which a first lottery game is played using balls; a supplier 10b for supplying game balls to the play field 10a; and a storage 10c having a second guide plate 162, which is one example of a configuration for storing balls discharged from the play field 10a and allowing the stored balls to move towards the supplier 10b, wherein the supplier 10b comprises a conveying unit 14 for conveying balls to the play field 10a and the ball guide 15 for guiding balls from the storage 10c successively to the conveying unit 14, and the ball guide 15 has a guide path 151 that passes the balls from the storage 10c toward the conveying unit 14 one by one, and an adjuster 152 that, when balls near an entrance 1511 of the guide path 151 on the storage 10c side are stacked above the height of the entrance 1511, moves at least one of the stacked balls to another position in the storage 10c. As a result, it is possible to avoid the occurrence of ball jams in the conveying unit 14 and achieve stable ball conveyance by the conveying unit 14, thereby providing a game device and a lottery game machine that can improve player satisfaction with the game.

The effect of employing the ball guide 15 in the first lottery game unit 10 will be described in more detail. The first lottery game unit 10 guides the balls from the storage 10c one by one in succession to the conveying unit 14 via the guide path 151, thereby avoiding both the problem of ball jamming on the conveying unit 14 side, where the balls mesh with the conveying unit 14 due to the time difference between the start time of a conveying operation of the conveying unit 14 and the time the balls are guided to the conveying unit 14, and the problem of ball jamming that can occur within the guide path 151. At the same time, the first lottery game unit 10 can eliminate the problem of ball stacking near the entrance 1511 of the guide path 151 via the adjuster 152, thereby avoiding the interruption or cessation of the guidance of the ball to the conveying unit 14 due to ball jamming that may occur in the ball movement path of the first lottery game unit 10 due to the stacking of balls. In this way, by adopting the ball guide 15 having a simple configuration, the first lottery game unit 10 can eliminate the occurrence of ball jamming near the conveying unit 14 and the occurrence of ball jamming on the side of the storage 10c away from the conveying unit 14. As a result, it is possible to achieve stable ball conveyance by the conveying unit 14, thereby providing a game device and a lottery game machine that can improve player satisfaction with the game.

Furthermore, in the first lottery game unit 10 according to the embodiments described above, the guide path 151 has the entrance 1511 and the exit 1512 located on the conveying unit 14 side, and the entrance 1511 is formed so as to allow balls from the storage 10c to enter the guide path 151 one by one, and the exit 1512 is formed so as to discharge the balls in the guide path 151 one by one to the conveying unit 14. As a result, the guide path 151 can be used to guide each ball to the conveying unit with a simple configuration, and ball jamming while moving toward the conveying unit 14 can be avoided.

Furthermore, in the first lottery game unit 10 according to the embodiments described above, before a plurality of balls sequentially enter the entrance 1511 from the storage 10c and are discharged from the exit 1512, the guide path 151 can align the plurality of balls in one row in which adjacent balls come into contact with each other. As a result, it is possible to easily avoid the occurrence of ball jamming due to engagement between the conveying unit 14 and the balls.

Furthermore, in the first lottery game unit 10 according to the embodiments described above, the adjuster 152 can have a piston configuration that pushes the ball in a direction away from the entrance 1511 of the guide path 151. As a result, using a simple configuration, it is possible to reliably prevent ball jamming on the entrance 1511 side of the guide path 151.

Furthermore, in the first lottery game unit 10 according to the embodiments described above, the supplier 10b further has a drive unit 140 that drives the ball conveying operation of the conveying unit 14, and the piston pin 154 of the piston configuration of the adjuster 152 is formed so as to be able to engage with the conveying unit 14, and when the piston pin 154 is engaged with the conveying unit 14, a piston operation of the piston pin 154 can be driven by the drive unit 140. As a result, the conveying unit 14 and the adjuster 152 can be driven by a single power source, thereby simplifying the structure and reducing manufacturing costs.

Furthermore, in the first lottery game unit 10 according to the embodiments described above, the guide path 151 can be defined by an adjuster 152 and a guide plate 159, which is one example of a wall unit that supports the ball and is provided at a position opposite the adjuster 152. As a result, the guide path 151 can be formed with a simple configuration, thereby making it possible to reduce the number of components.

Furthermore, in the lottery game machine 1 according to the embodiments described above, there is provided a lottery game machine 1, which is one example of a lottery game unit that conducts a lottery game using any one of the first lottery game units 10 described above, the start medium receiving unit 34 for receiving a game start medium through operation by a player, a medium dispenser 40 for dispensing a game result medium to the player, and a controller 60 configured to dispense a game result medium corresponding to the lottery result to the medium dispenser 40 based on the lottery result of the lottery game started by the lottery game unit when the start medium receiving unit 34 receives the game start medium. As a result, it is possible to use a simple configuration to avoid ball jamming in the first lottery game unit 10, to ensure that the lottery game is carried out stably, and to improve the player's satisfaction with the game.

The present invention is not limited to the embodiments described above, and as long as the features of the invention are included, the scope of the invention also includes design changes that a person skilled in the art could make to these embodiments as appropriate. For example, game machines other than Corinth games, smart ball cabinets and the like, and other game devices that use guide pins, play boards, and play media are included within the scope of the present invention. In other words, each of the elements of the embodiments described above and their arrangement, materials, conditions, shapes, sizes, and the like are not limited to those exemplified, and can be modified as appropriate. Furthermore, the elements of each of the above-described embodiments can be combined to the extent technically possible, and such combinations are also included within the scope of the present invention as long as they include the features of the present invention.

### DESCRIPTION OF REFERENCE NUMERALS

1 . . . lottery game machine
10 . . . first lottery game unit
10a . . . play field
10b . . . supplier
10c . . . storage
14 . . . conveying unit
15 . . . ball guide
34 . . . starting medium receiving unit
40 . . . medium dispenser
60 . . . controller
140 . . . drive unit
151 . . . guide path
152 . . . adjuster
159 . . . guide plate
1511 . . . entrance
1512 . . . exit

What is claimed is:

1. A game device comprising:
a play field in which a game is played using balls;
a supplier that supplies the balls to the play field; and
a storage that is configured to store the balls discharged from the play field and allow the balls to move towards the supplier, wherein
the supplier comprises:
a conveying unit that conveys the balls to the play field; and
a ball guide that guides the balls from the storage successively to the conveying unit, and
the ball guide comprises:
a guide path that passes the balls from the storage toward the conveying unit; and
an adjuster that allows at least one of the balls near an entrance of the guide path on a side of the storage to move to another position in the storage, in response to the one of the balls being stacked to be above a height of the entrance.

2. The game device according to claim 1, wherein
the guide path has the entrance and an exit located on a side of the conveying unit,
the entrance is formed to allow the balls from the storage to enter the guide path one by one, and
the exit is formed to discharge the balls in the guide path one by one to the conveying unit.

3. The game device according to claim 2, wherein,
before the balls sequentially enter the entrance from the storage and are discharged from the exit, the guide path aligns the balls in one row in which adjacent balls are in contact with each other.

4. The game device according to claim 1, wherein
the adjuster has a piston that pushes the balls in a direction away from the entrance.

5. The game device according to claim 4, wherein
the supplier further comprises:
a driver that drives a ball conveying operation of the conveying unit,
the piston of the adjuster is configured to be engageable with the conveying unit, and
in a state that the piston engages with the conveying unit, a piston operation of the piston is driven by the driver.

6. The game device according to claim 5, wherein
the guide path is defined by the adjuster and a guide plate that faces the adjuster and supports the balls.

7. A lottery game machine comprising:
a lottery game unit that conducts a lottery game using the game device according to claim 1,
an input slot that receives a start medium input by a player,
a medium dispenser that dispenses a game result medium to the player, and
a controller configured to dispense the game result medium corresponding to a lottery result of the lottery game that was started in response to the input slot receiving the start medium, to the medium dispenser based on the lottery result.
